(19) United States
(12) Patent Application Publication
(10) Pub. No.: US 2024/0385285 A1
(43) Pub. Date: Nov. 21, 2024

(54) RADAR PULSE COMPRESSION

(71) Applicant: University Corporation for Atmospheric Research, Boulder, CO (US)

(72) Inventor: Adam Karboski, Boulder, CO (US)

(21) Appl. No.: 18/667,438

(22) Filed: May 17, 2024

Related U.S. Application Data
(60) Provisional application No. 63/502,841, filed on May 17, 2023.

(51) Int. Cl. G01S 7/285

(52) U.S. Cl. CPC G01S 7/285

(57) ABSTRACT

A method may receive a return signal array from a pulsed radar. A method may generate a filtered signal output by executing a convolution operation with the return signal array and a set of filters including a first filter that is different from and a second filter, and wherein the first filter is applied to the return signal array based on a first range cell index of the return signal array and the second filter is applied to the return signal array based on a second range cell index of the return signal array.

### CROSS-REFERENCE TO RELATED APPLICATION

This application claims priority to U.S. Provisional Patent Application No. 63/502,841, filed on May 17, 2023, the disclosure of which is incorporated by reference herein in its entirety.

### STATEMENT REGARDING FEDERALLY SPONSORED RESEARCH OR DEVELOPMENT

This invention was made with Government support under award 1755088, awarded by the National Science Foundation, and award NA18OAR4590431, awarded by the National Oceanic and Atmospheric Administration. The Government has certain rights in this invention.

### BACKGROUND

Pulse compression is used with pulse radars to aid in measuring and/or classifying radar echoes by range cell according to their distance. A pulse compressor executes post-processing, typically applying the same mathematical transformation filter to each range cell sequentially. When the duration of the transmit pulse is longer than the round-trip propagation of an echo of interest, however, the echo is partially obscured by the transmitter, resulting in interference and difficulty resolving a signal.

### SUMMARY

In some aspects, the techniques described herein relate to a method including: receiving a return signal array from a pulsed radar; and generating a filtered signal output by executing a convolution operation with the return signal array and a set of filters including a first filter that is different from and a second filter, and wherein the first filter is applied to the return signal array based on a first range cell index of the return signal array and the second filter is applied to the return signal array based on a second range cell index of the return signal array.

In some aspects, the techniques described herein relate to a computing device including: a processor; and a memory configured with instructions operable to: receive a return signal array from a pulsed radar; and generate a filtered signal output by executing a convolution operation with the return signal array and a set of filters including a first filter that is different from and a second filter, and wherein the first filter is applied to the return signal array based on a first range cell index of the return signal array and the second filter is applied to the return signal array based on a second range cell index of the return signal array.

In some aspects, the techniques described herein relate to a method including: receiving a full convolution filter A_{F} representing a radar pulse; generating a modified convolution filter A_{M} by removing at least one column of full convolution filter A_{F} representing a blind range signal and removing at least one row of a full convolution filter A_{F} that corresponds to a portion of a main lobe; and generating a set of filters x, wherein, a is a transmit pulse, and C=A^{H}A.

### BRIEF DESCRIPTION OF THE DRAWINGS

FIG. 1 depicts a flowchart, according to examples described throughout this disclosure.

FIG. 2A depicts filter and return signal convolution diagrams, according to examples described throughout this disclosure.

FIG. 2B depicts filter and return signal convolution diagrams, according to examples described throughout this disclosure.

FIG. 3A depicts the output of prior pulse compression filter methods.

FIG. 3B depicts the output of pulse compression filter methods according to the disclosure.

FIG. 4A depicts an ambiguity function, in accordance with an example.

FIG. 4B depicts a sensitivity function, in accordance with an example.

FIG. 5 depicts a system diagram, in accordance with an example.

### DETAILED DESCRIPTION

Radar pulse compression is a technique used in radar systems to improve range resolution capabilities. Pulse compression may be achieved by generating a matched or unmatched filter based on the radio frequency (RF) transmit pulse. The filter is then convolved with a return signal w, producing a compressed pulse that is better optimized for signal to noise. The use of pulse compression can allow for closely spaced targets to be resolved for the location and characteristics of a target to be more accurately determined.

For any radar pulse length, there is a blind range (e.g., blind range region) near the radar. In the blind range, the radar pulse has not had enough time to be fully emitted before its reflection starts to arrive back at the radar, leading to interference that can cause errors in the measurement. The size of the blind zone is determined at least in part by the pulse length. For radars with a pulse length of 40 μs, for example, the blind zone can encompass the 6 km closest to the instrument.

Some radars adjust the pulse width to make the blind zone smaller. For example, pulse widths of 1 ms are possible. While shortening the pulse length may shorten (but not eliminate) the blind zone, it may sacrifice the signal to noise ratio and the range resolution of the radar.

In prior pulse compression, a radar pulse is processed by selecting or creating a single filter, or a vector of coefficients, for example x, and applying that one filter to all of the range cells that are processed. In examples, the filter x may comprise the time-reversed conjugate of the transmitted pulse A, as designed or measured by the detector. In other pulse compression methods, however, the filter x may comprise an unmatched filter optimized to minimize sidelobes or to achieve another performance metric.

The filtering used in prior pulse compression algorithms is represented by Table 1below.

TABLE 1

| Range Cell Index | 1 | 2 | 3 | 4 | 5 | 6 | . . . N |
|---|---|---|---|---|---|---|---|
| Filter x | n/a | n/a | n/a | x1 | x1 | x1 | x1 |
| Return signal x | 1 . . . 3 | 2 . . . 4 | 3 . . . 5 | 4 . . . 6 | 5 . . . 7 | 6 . . . 8 | N . . . N + 2 |
| index | | | | | | | |

| | | |
|---|---|---|
| Region | Blind Range | Far Range |

In the example of Table 1, the blind range includes range cells 1-3, and the far range includes range cell 4 onward. The transmitted pulse is three samples long; therefore, each range cell is computed from three sample points. Under prior methods, filter x may therefore comprise a vector with three coefficients to match the length of the transmitted pulse.

As may be further seen, in Table 1, in prior systems there is one filter x selected for the entire range (filter 1) and either: no pulse filtering is performed in the blind range, or filtering is performed in the blind range but the result is discarded, or the data is accepted with the knowledge that it is of degraded quality. The reason that data is unusable or degraded in the blind range is because at least a portion of the pulse being transmitted overlaps with the return signal w (e.g., return signal array) from the same pulse, causing interference in the detector. The interference may arise due to the transmit pulse energy saturating the receiver, or due to active mechanisms that protect the receiver from damage caused by the energy.

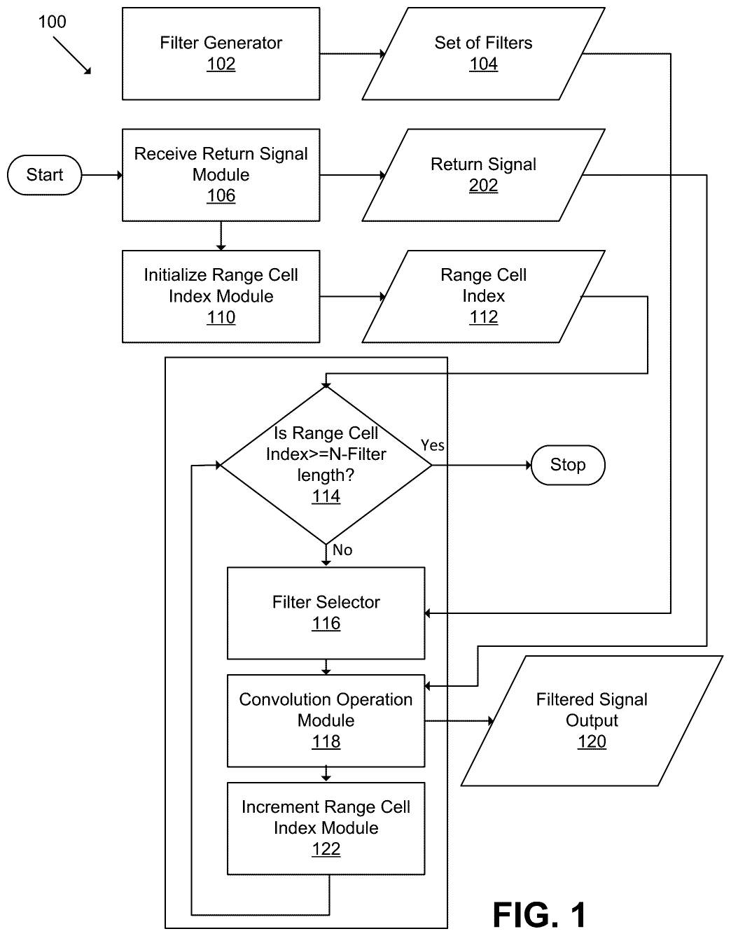

In the present disclosure, a set of filters are generated by a filter generator. For example, this is shown in FIG. 1, which depicts a flow diagram 100 in accordance with an example. Flow diagram 100 may be used to generate pulse compression filters and apply them to perform pulse compression on a returned radar signal.

Flow diagram 100 includes a filter generator 102 that produces set of filters 104. In examples, filter generator 102 may generate set of filters 104 using various properties of the radar, such as the pulse length and/or shape. In examples, filter generator 102 may generate set of filters 104 to optimize favorable features, such as a signal to noise ratio, or to minimize disfavored features, such as sidelobes. In examples filter generator 102 may be generated to optimize other features as well.

In examples, filter generator 102 may be used to generate a set of filters 104 before the other steps of flow diagram 100 are executed. In examples, filter generator 102 may generate one or more of set of filters 104 during runtime of the pulse compression algorithm.

Each filter of set of filters 104 may correspond to a range of distances from the radar transmitter/receiver electronics, as indicated by range cell index. In examples, each filter of set of filters 104 may correspond to one range cell index or a range of range cell indexes.

For example, in Table 2, it is shown that set of filters 104 may include several filters x applied to different potions of return signal w. In the example, there is one filter x (filter x4), selected for the far range where the radar pulse is fully emitted before it returns, and at least one additional filter x (filters x1-x3) applied to the blind range.

TABLE 2

| Range Cell Index | 1 | 2 | 3 | 4 | 5 | 6 | 7 | . . . N |
|---|---|---|---|---|---|---|---|---|
| Filter x selected | x1 | x1 | x2 | x2 | x3 | x3 | x4 | x4 |
| from a Set of | | | | | | | | |
| Filters | | | | | | | | |
| Return signal w | 1 . . . 5 | 2 . . . 6 | 3 . . . 7 | 4 . . . 8 | 5 . . . 9 | 6 . . . 10 | 7 . . . 11 | N . . . N + 4 |
| index | | | | | | | | |

| | | |
|---|---|---|
| Region | Blind Range | Far Range |

Each of the filters x in Table 2 is designed to be applied to two range cells. This is only for the sake of example, however. In further examples, filter x may include any length or number of range cells.

Return signal w is time-series that includes a linear superposition of returned transmitted pulses reflected off targets (such as raindrops) illuminated by the radar transmitter.

In examples, filter generator 102 may determine set of filters 104 as follows. The output b of the pulse compression filter (e.g., a filtered signal output) is the convolution sequence of the full convolution filter A_{F} (e.g., the transmitted pulse, a matched filter) and the received filter x (e.g., a vector array of coefficients):

$$b = {A}_{F} x \qquad ( Equation 1 )$$

$$b = {[ {b}_{1} {b}_{2} … {b}_{2 N - 1} ]}^{T} \qquad ( Equation 2 )$$

$$x = {[ {x}_{1} {x}_{2} … {x}_{N} ]}^{T} \qquad ( Equation 3 )$$

$${A}_{F} = {[ \begin{matrix}{a}_{1} & {a}_{2} & … & {a}_{N} & 0 & … & 0 \\ 0 & {a}_{1} & … & {a}_{N - 1} & {a}_{N} & … & 0 \\ ⋮ & & & ⋮ & & & ⋮ \\ 0 & … & {a}_{1} & {a}_{2} & … & {a}_{N} & 0 \\ 0 & … & 0 & {a}_{1} & {a}_{1} & … & {a}_{N}\end{matrix} ]}^{T} . \qquad ( Equation 4 )$$

The transpose of a vector or matrix is denoted by ^{T} and the transmitted pulse A is represented in the form of a full convolution filter A^{F}. In examples, full convolution filter A_{F} may be based on a commanded pulse shape or based on a measured pulse shape.

Note that ^{T} denotes the transpose of a vector or matrix and that A_{F} is the full convolution matrix. The above formulation leads to the following convenient expression for the sum-of-squares of the convolution sequence.

$${b}^{H} b = {‖ {b}_{1} ‖}^{2} + {‖ {b}_{2} ‖}^{2} + … + {‖ {b}_{2 N - 1} ‖}^{2} \qquad ( Equation 5 )$$

where ^{H} denotes the complex conjugate transpose. The sidelobe measure function for a compressed pulse can now be formulated by defining a new matrix for a filter n of the set of filters 104, modified convolution filter A^{Mn}, which is similar to A^{F}, except that the rows in A^{F} which produce the compression peak, or portions of the main lobe, may be removed. Columns that represent obscured and/or missing signal data in the blind range may further be removed in the modified convolution filter A^{Mn}. The sidelobe measure cost function to be minimized can therefore be written as:

$$f ( x ) = {b}^{H} b = {x}_{n}^{H} {A}_{M n}^{H} {A}_{M n} x = {x}_{n}^{H} {C}_{n} {x}_{n} \qquad ( Equation 6 )$$

$$where {C}_{n} = {A}_{M n}^{H} {A}_{M n} \qquad ( Equation 7 )$$

Using the method of Lagrange multipliers, a solution for x may be found that will minimize the sidelobe measure cost function while satisfying the constraint that a pulse compression peak with amplitude bₚₑₐₖ must be produced. This constraint can be written as:

$$a x = {b}_{p e a k} \qquad ( Equation 8 )$$

Where a is a transmit pulse:

$$a = [ {a}_{N} {a}_{N - 1} … {a}_{1} ] \qquad ( Equation 9 )$$

In examples, bₚₑₐₖ may be a gain factor. In examples, bₚₑₐₖ may be set to 1. In examples, a may be extended with zeros to produce a longer filter. This leads to the constraint function:

$$g ( x ) = a {x}_{n} - {b}_{p e a k} = 0 \qquad ( Equation 10 )$$

In an example, no constraint is placed on the samples adjacent to the peak sample and no symmetry constraints are placed on the filter response.

A system of simultaneous equations may arise from the complex Lagrangian:

$$\frac{d}{d x *} ( f ( x ) ) + \frac{d}{d x *} ( R e \{ λ * g ( x ) \} ) = 0 \qquad ( Equation 11 )$$

and the constraint given in Equation 10. This extended system of simultaneous equations may now be solved to obtain the value of filter x that minimizes the sidelobe measure:

$${x}_{n} = \frac{{b}_{p e a k} {C}_{n}^{- 1} {a}^{H}}{{aC}_{n}^{- 1} {a}^{H}} n = 1 , 2 , 3 … \qquad ( Equation 12 )$$

where n is the filter number in the set of filters 104. This solution for filter xₙ may produce a mismatched received filter for the transmit pulse {aₙ} that minimizes the pulse compression sidelobes in the least-squares sense, i.e., it may be equivalent to minimizing the L₂-norm of the sidelobes. Following a similar approach, the generalized expression for the L_{2P}-norm case can now be derived.

Set of filters 104 may include at least two filters associated with a different ranges of return signal w. In an example, a filtered signal output may be generated by executing a convolution operation with the return signal w and set of filters 104 including a first filter that is different from and a second filter. The first filter may be applied to the return signal w based on a first range cell index of the return signal w and the second filter may be applied to the return signal array based on a second range cell index of the return signal w. In an example, the first filter may be applied to a blind range region and the second filter may be applied to a far range region of the return signal w.

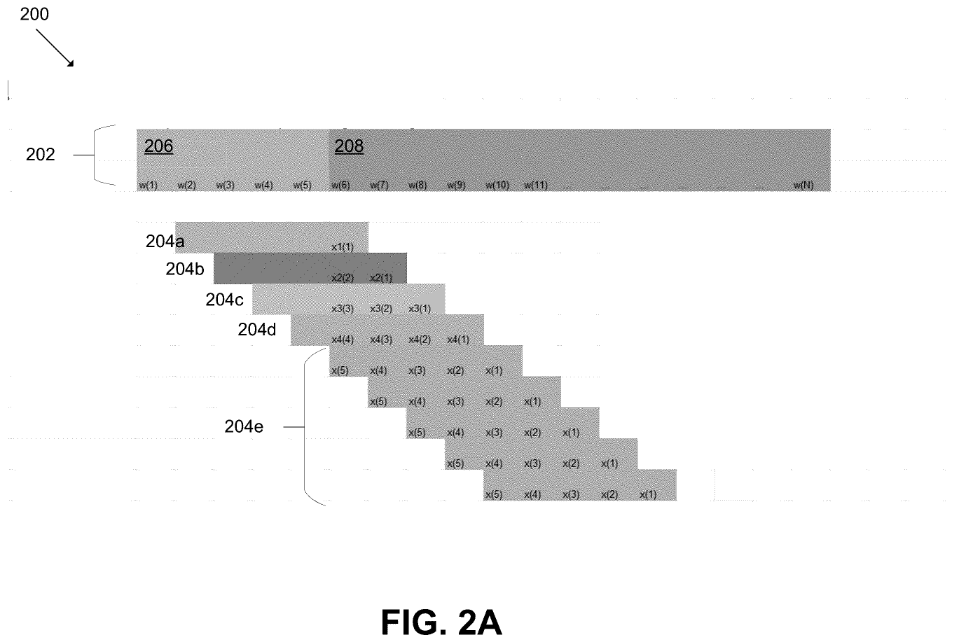

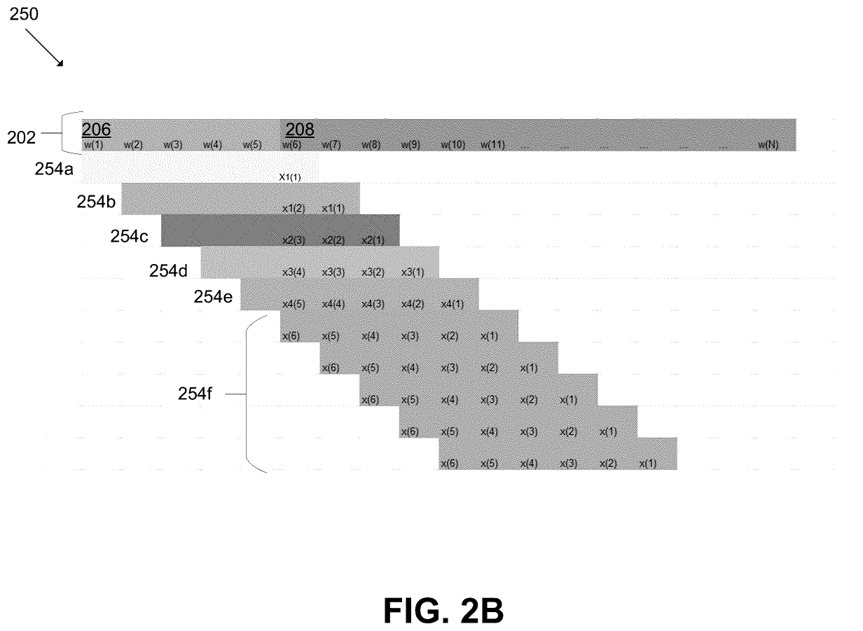

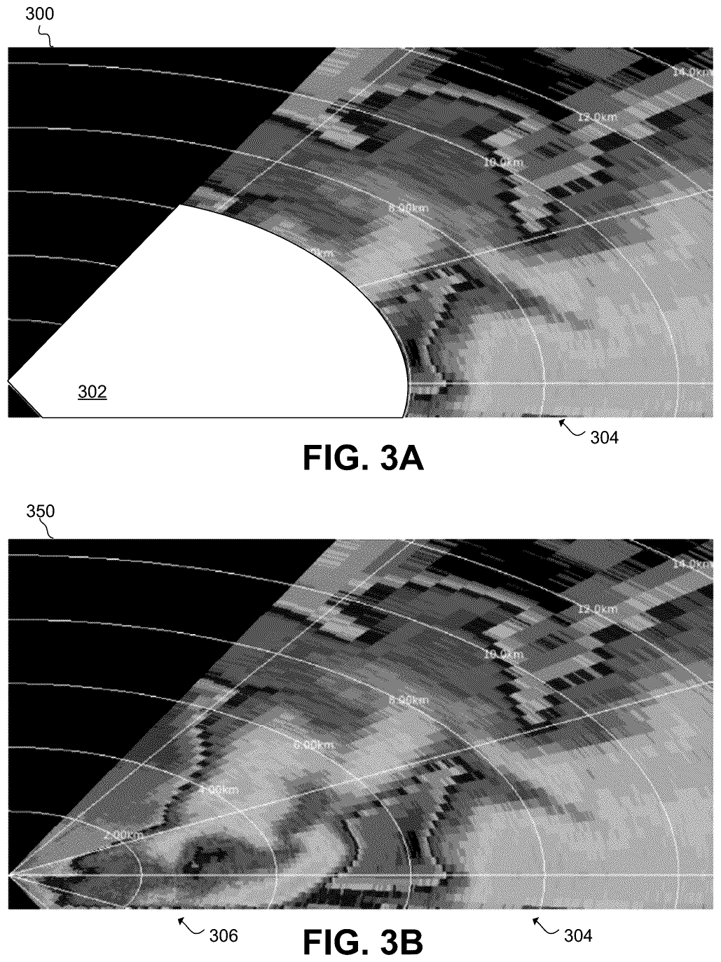

The convolution operation using set of filters 104 is further described with respect to FIG. 2A below.

FIG. 2A depicts a filter and return signal convolution diagram 200 according to an example. Return signal w 202 is depicted across the top of signal convolution diagram 200 with range cell indexes noted, w(1), w(2), w(3) . . . w(N). The index values w(1)-w(5) represent the blind range 206, where interference occurs because the transmitted pulse A is not fully emitted. The index value of w(6) . . . w(N) is the far range 208, where the pulse is fully emitted and traditional pulse compression may be used.

FIG. 2A depicts filter x 204e, which is applied throughout the entire far range 208. The reason that there may be one filter x 204e applied throughout the entire far range 208 is because there are no columns to remove from the full convolution filter A_{F} because none of the signal is obscured in the blind zone. As is shown in the figure, filter x 204e includes five coefficients, x=[x(1) x(2) x(3) x(4) x(5)]. This is not intended to be limiting, however, any length of filter x is possible. As is shown, during the convolution filter x 204e is applied first to return signal w 202 range cells w(6)-w(11) before subsequently shifting one range cell to the right and being applied again until range cell w(N) is eventually reached.

For blind range 206, however, at least one filter x is generated that is different from the far range 208 filter x. In the example, there are four separate filters x created for application within blind range 206: filter x1 204a, filter x2 204b, filter x3 204c, and filter x4 204d. Each of filter x1 204a, filter x2 204b filter x3 204c, and filter x4 204d are similar to filter x 204e, except that the cost function described above is modified when columns of full convolution filter A_{F} that have obscured or missing data due to the blind range 206 are removed. Filter x1 204a, filter x2 204b filter x3 204c, and filter x4 204d may be shortened correspondingly or some coefficients may be zero. The filters x may then be applied to the return signal w to generate output b. For example, filter x1 204a is applied between range cells w(2) to w(5) in blind range 206 and only to range cell w(6) within far range 208. In an example, filter x1 204a includes only a single coefficient, x1(1), which aligns with range cell w(6). Similarly, filter x2 204b is shifted one range cell to the right so that it overlaps with two range cells of far range 208 and therefore includes two coefficients, x2=[x2(1) x2(2)]. Filter x3 204c is shifted one range cell to the right of x2 and therefore includes three coefficients x3=[x3(1) x3(2) x3(3)]. Filter x4 204d is shifted one range cell to the right of x3 and therefore includes four coefficients x4=[x4(1) x4(2) x4(3) x4(4)]. In this way, filter generator 102 may generate set of filters 104 X=[x1 x2 x3 x4 x].

Signal convolution diagram 200 is not intended to be limiting. In examples, it may be possible to generate any number of filters x for blind range 206 that are equal to or smaller than the number of range cells within blind range 206. For example, each filter x of set of filters 104 may be applied to 1, 2, or N range cells.

In the example of signal convolution diagram 200, there no filter x is applied to range cells w(1)-w(5). The reason is because the width of the filter matches the width of blind range 206. In other examples, however, it may be possible to create a filter for this range of range cells with all zero coefficients.

FIG. 2B depicts a further filter and return signal convolution diagram 250 according to an example. Signal convolution diagram 250 is similar to signal convolution diagram 200 except that each filter x of set of filters 104 has six coefficients instead of one. A longer filter x Filter x 254f, which is only applied to range cells within far range 208, includes six coefficients x=[x(1) x(2) x(3) x(4) x(5) x(6)].

Within blind range 206 of signal convolution diagram 250, however, filter x1 254a includes only a single coefficient, x1(1), which aligns with range cell w(6). Similarly, filter x2 254b is shifted one range cell to the right so that it overlaps with two range cells of far range 208 and therefore includes two coefficients, x2=[x2(1) x2(2)]. Filter x3 254c is shifted one range cell to the right of x2 and therefore includes three coefficients x3=[x3(1) x3(2) x3(3)]. Filter x4 254d is shifted one range cell to the right of x3 and therefore includes four coefficients x4=[x4(1) x4(2) x4(3) x4(4)]. Filter x5 254e is shifted one range cell to the right of x4 and therefore includes five coefficients x5=[x5(1) x5(2) x5(3) x5(4) x5(5)]. In the example of signal convolution diagram 250, filter generator 102 generates set of filters 104 X=[x1 x2 x3 x4 x5 x]. The pulse length is as long as blind range 206 and extending the filter x beyond a pulse length (to include range cells beyond blind range 206) may discriminate between a desired signal and an undesired signal (such as a sidelobe) than a shorter filter.

After set of filters 104 is generated, they may be used to perform pulse compression on return signal w 202. Returning to FIG. 1, it is shown that a return signal module 106 receives return signal w 202. Next initialize range cell index module 110 may executed. In initialize range cell index module 110, a range cell index 112 may be initialized to 0, N, or any other range cell number. In the example of signal convolution diagram 200 and signal convolution diagram 250, range cell index 112 is initialized to zero.

Next flow diagram 100 continues with decision box 114. In decision box 114, it is determined whether the range cell index 112 is greater than or equal to N minus the length of filter x, which should include the last range cell of return signal w 202. If decision box 114 evaluates true, the method may conclude. If decision box 114 evaluates false, however, then flow diagram 100 may continue onto filter selector 116.

Filter selector 116 is operable to select a filter x from set of filters 104 based on range cell index 112. For example, in signal convolution diagram 200 if range cell index 112 is w(4), filter x3 is selected. If range cell index 112 is x(5), x4 may be selected. And so forth.

In examples, flow diagram 100 may continue with convolution operation module 118. In convolution operation module 118 the modified convolution operation may be performed, where each element is computed as:

$${w}^{′} ( i ) = {\sum }_{k} {x}_{i} ( i + 1 - k ) \cdot w ( k ) \qquad ( Equation 13 )$$

The output of the convolution operation of equation 13 is a filtered signal output w′ 120. Filtered signal output w′ 120 may have improved signal to noise over return signal w 202, in addition to reduced sidelobes.

In examples, flow diagram 100 may continue with increment range cell index module 122. Increment range cell index module 122 may increment range cell index 112 until range cell index 112 reaches the end of return signal w 202.

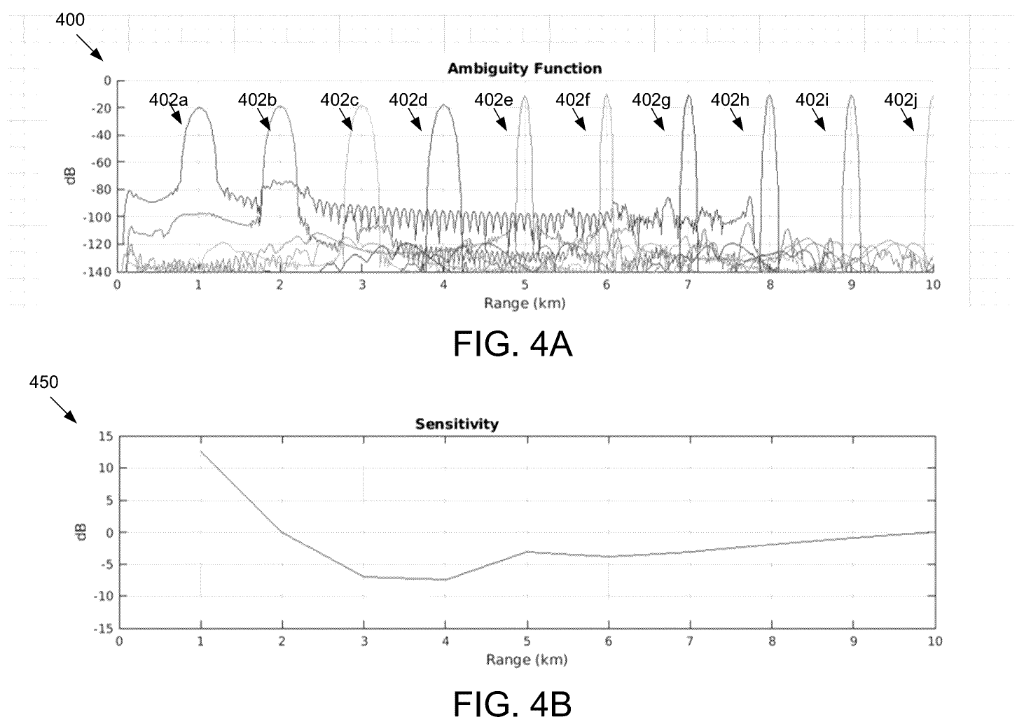

The methods described herein provide greater performance in the blind zone of a pulsed radar. Turning to FIG. 4A, diagram 400 depicts an ambiguity function of set of filters 104, according to an embodiment. Each of 402a-402j represent a peak in a different respective returned signal w spaced at 1 km distance intervals from the transmitter. The blind range in the diagram is 6 km, which corresponds to the area between 402a and 402f. As may be seen in the diagram, the peak 402a closest to the radar has widest pulse width, indicating the lowest resolution. The pulse widths become narrower and narrower as they approach 6 km from the radar (402f) as the resolution increases through the blind range. In the far range, each pulse (402f-402i) is approximately equal in width.

FIG. 4B depicts a diagram 450 depicting a sensitivity threshold of the signal for based on set of filters 104. As may be seen, the sensitivity threshold improves from 1 km in the radar to 3 and 4 km, where set of filters 104 are the most sensitive. After 4 km, the sensitivity threshold decreases.

In examples, any combination of steps from flow diagram 100 may be implemented software or on a Field Programmable Gate Array (FPGA).

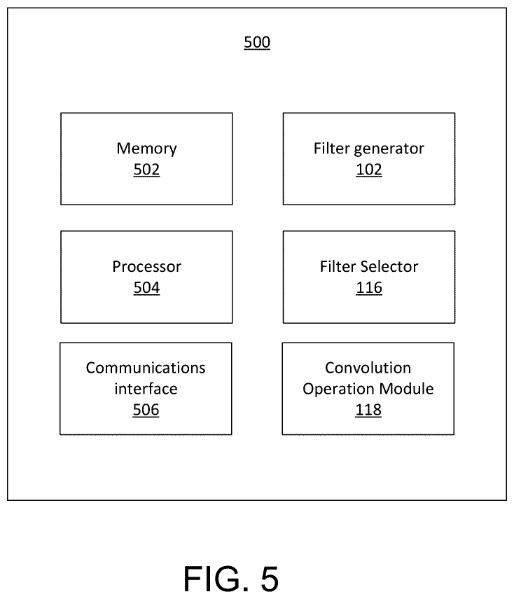

FIG. 5 depicts a device 500, according to an example. Device 500 may be any type of consumer computing device, server, or embedded device. Device 500 may be operable to execute any of the methods described herein.

Device 500 includes a memory 502, a processor 504, and a communication interface 506.

In examples, processor 504 may include multiple processors, and memory 502 may include multiple memories. Processor 504 may be configured with instructions to generate the filters or perform the convolution operations described in the disclosure. The instructions may include non-transitory computer-readable instructions stored in, and recalled from, memory 502. In an example, any portion of memory 502 and/or processor 504 may be implemented in an FPGA.

Communication interface 506 of device 500 may be operable to facilitate communication between device 500 a radar, a server, or another computing device. In examples, communication interface 506 may utilize short-range wireless communication protocols, such as BLUETOOTH, Wi-Fi, Zigbee™, or any other wireless or wired communication methods.

In examples, device 500 may further include any combination of a filter generator 102, a filter selector 116, and a convolution operation module 118.

Potential applications for the methods described herein include weather radar, radar for other purposes, bistatic or multistatic radars, radio navigation systems, lidar, sonar, transmitter location/ranging systems, and telecommunications.

In examples, any steps from flow diagram 100 may be implemented on any processing hardware or via software.

In some aspects, the techniques described herein relate to a method, wherein the first filter is applied to a blind range region and the second filter is applied to a far range region of the return signal array.

In some aspects, the techniques described herein relate to a method, wherein each filter x of the set of filters has a length that is greater than a length of the blind range region.

In some aspects, the techniques described herein relate to a method, wherein the first filter and the second filter are generated by minimizing a sidelobe measure cost function.

In some aspects, the techniques described herein relate to a method, wherein the set of filters are generated by: receiving a full convolution filter A_{F} representing a radar pulse; generating a modified convolution filter A_{Mn} by removing at least one column of full convolution filter A_{F} representing a blind range signal and removing at least one row of a full convolution filter A_{F} that corresponds to a portion of a main lobe; and generating a set of filters x, wherein, n is an index of the set of filters, a is a transmit pulse, and Cn=A_{Mn}^{H}A_{Mn}.

In some aspects, the techniques described herein relate to a computing device, wherein the first filter is applied to a blind range region and the second filter is applied to a far range region of the return signal array.

In some aspects, the techniques described herein relate to a computing device, wherein each filter xₙ of the set of filters x has a length that is greater than a length of the blind range region.

In some aspects, the techniques described herein relate to a computing device, wherein the first filter and the second filter are generated by minimizing a sidelobe measure cost function.

In some aspects, the techniques described herein relate to a computing device, wherein the memory is further configured with instructions to generate the set of filters x are generated by: receiving a full convolution filter A^{F} representing a radar pulse; generating a modified convolution filter A_{Mn} by removing at least one column of full convolution filter A^{F} representing a blind range signal and removing at least one row of a full convolution filter A^{F} that corresponds to a portion of a main lobe; and generating a set of filters x, wherein, n is an index of the set of filters, a is a transmit pulse, and Cn=A_{Mn}^{H}A_{Mn}.

In some aspects, the techniques described herein relate to a method, wherein the full convolution filter A_{F} represents a measured radar pulse.

In some aspects, the techniques described herein relate to a method, wherein the set of filters x includes a first filter for a blind range region of the return signal array and a second filter for a far range region of the return signal array.

In some aspects, the techniques described herein relate to a method, wherein each filter xₙ of the set of filters has a length that is greater than a length of the blind range region.

The methods and devices described herein allow a radar operator to extract ranging information from the range cells in the blind zone closest to the radar, thereby improving range resolution and reducing range side-lobes measurement errors.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. Various implementations of the systems and techniques described here can be realized as and/or generally be referred to herein as a circuit, a module, a block, or a system that can combine software and hardware aspects. For example, a module may include the functions/acts/computer program instructions executing on a processor or some other programmable data processing apparatus.

Some of the above example implementations are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example implementations. Example implementations, however, have many alternate forms and should not be construed as limited to only the implementations set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed items.

The terminology used herein is for the purpose of describing particular implementations only and is not intended to be limiting of example implementations. As used herein, the singular forms a, an, and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example implementations belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example implementations and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative implementations, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), Graphics Processing Units (GPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example implementations are typically encoded on some form of non-transitory program storage medium or implemented over some type of transmission medium. The program storage medium may be magnetic (e.g., a floppy disk or a hard drive), solid state, or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations are not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or implementations herein disclosed irrespective of whether or not that particular combination has been specifically enumerated in the accompanying claims at this time.

What is claimed:

1. A method comprising:
receiving a return signal array from a pulsed radar; and
generating a filtered signal output by executing a convolution operation with the return signal array and a set of filters including a first filter that is different from and a second filter, and wherein the first filter is applied to the return signal array based on a first range cell index of the return signal array and the second filter is applied to the return signal array based on a second range cell index of the return signal array.

2. The method of claim 1, wherein the first filter is applied to a blind range region and the second filter is applied to a far range region of the return signal array.

3. The method of claim 2, wherein each filter x of the set of filters has a length that is greater than a length of the blind range region.

4. The method of claim 1, wherein the first filter and the second filter are generated by minimizing a sidelobe measure cost function.

5. The method of claim 1, wherein the set of filters are generated by:
receiving a full convolution filter A_{F} representing a radar pulse;
generating a modified convolution filter Am n by removing at least one column of full convolution filter A_{F} representing a blind range signal and removing at least one row of a full convolution filter A_{F} that corresponds to a portion of a main lobe; and
generating a set of filters x, wherein
$${x}_{n} = \frac{{b}_{p e a k} {C}_{n}^{- 1} {a}^{H}}{{aC}_{n}^{- 1} {a}^{H}} ,$$
n is an index of the set of filters, a is a transmit pulse, and Cn=A_{Mn}^{H}A_{Mn}.

6. A computing device comprising:
a processor; and
a memory configured with instructions operable to:
receive a return signal array from a pulsed radar; and
generate a filtered signal output by executing a convolution operation with the return signal array and a set of filters including a first filter that is different from and a second filter, and wherein the first filter is applied to the return signal array based on a first range cell index of the return signal array and the second filter is applied to the return signal array based on a second range cell index of the return signal array.

7. The computing device of claim 6, wherein the first filter is applied to a blind range region and the second filter is applied to a far range region of the return signal array.

8. The computing device of claim 7, wherein each filter xₙ of the set of filters x has a length that is greater than a length of the blind range region.

9. The computing device of claim 6, wherein the first filter and the second filter are generated by minimizing a sidelobe measure cost function.

10. The computing device of claim 6, wherein the memory is further configured with instructions to generate the set of filters x are generated by:
receiving a full convolution filter A_{F} representing a radar pulse;
generating a modified convolution filter Am n by removing at least one column of full convolution filter A_{F} representing a blind range signal and removing at least one row of a full convolution filter A_{F} that corresponds to a portion of a main lobe; and
generating a set of filters x, wherein
$${x}_{n} = \frac{{b}_{p e a k} {C}_{n}^{- 1} {a}^{H}}{{aC}_{n}^{- 1} {a}^{H}} ,$$
n is an index of the set of filters, a is a transmit pulse, and Cn=A_{Mn}^{H}A_{Mn}.

11. A method comprising:
receiving a full convolution filter A_{F} representing a radar pulse;
generating a modified convolution filter Am n by removing at least one column of full convolution filter A_{F} representing a blind range signal and removing at least one row of a full convolution filter A_{F} that corresponds to a portion of a main lobe; and
generating a set of filters x, wherein
$${x}_{n} = \frac{{b}_{p e a k} {C}_{n}^{- 1} {a}^{H}}{{aC}_{n}^{- 1} {a}^{H}} ,$$
n is an index of the set of filters, a is a transmit pulse, and Cn=A_{Mn}^{H}A_{Mn}.

12. The method of claim 11, wherein the full convolution filter A_{F} represents a measured radar pulse.

13. The method of claim 11, wherein the set of filters x includes a first filter for a blind range region of the return signal array and a second filter for a far range region of the return signal array.

14. The method of claim 11, wherein each filter xₙ of the set of filters has a length that is greater than a length of the blind range region.
